(19) United States
(12) Patent Application Publication
(10) Pub. No.: US 2009/0099045 A1
(43) Pub. Date: Apr. 16, 2009

(54) METHODS AND DEVICES FOR MOLECULAR ASSOCIATION AND IMAGING

(75) Inventors: George Jackson, Pearland, TX (US); Roger McNichols, Pearland, TX (US); Charles Houssiere, Houston, TX (US)

Correspondence Address: BIO TEX, INC., 8058 EL RIO STREET, HOUSTON, TX, 77054, US

(73) Assignee: BIOTEX, INC., Houston, TX (US)

(21) Appl. No.: 12/249,525

(22) Filed: Oct. 10, 2008

Related U.S. Application Data
(60) Provisional application No. 60/979,066, filed on Oct. 10, 2007.

(51) Int. Cl. C40B 50/18; C40B 60/14

(52) U.S. Cl. 506/32; 506/40

(57) ABSTRACT

The present invention is directed to devices and methods for molecular association, particularly to devices and methods for hybridization of nucleic acids utilizing temperature gradients and imaging thereof. In one aspect, a molecular hybridization system generally includes a substrate having a plurality of molecular probes attached thereto, the plurality of probes being generally present in multiple copies arranged in localized formations on the surface of the substrate. The molecular hybridization system further generally includes a chamber that encloses the plurality of molecular probes such that a fluid containing sample may be applied and kept in contact with the substrate having the probes thereon. The molecular hybridization system also includes a temperature affecting system that generally produces at least one desired temperature on the surface of the substrate and in the adjacent fluid within the chamber.

### CROSS-REFERENCE TO RELATED APPLICATIONS

This application claims the benefit of U.S. provisional patent application Ser. No. 60/979,066, filed Oct. 10, 2007, entitled “METHODS AND DEVICES FOR MOLECULAR ASSOCIATION AND IMAGING”, the entire contents of which is hereby incorporated by reference.

### FIELD OF THE INVENTION

This invention relates to devices and methods for molecular association, particularly to devices and methods for hybridization of nucleic acids utilizing temperature gradients and imaging thereof.

### BACKGROUND OF THE INVENTION

A number of technological advances have broadened the use of synthetic DNA or RNA oligonucleotide microarrays for research. Oligonucleotide microarrays are planar surfaces with spatially addressable immobilized subregions or “spots” containing known DNA or RNA sequences, called probes. By applying a mixture of labeled target, usually by fluorescent dyes, probes hybridize through Watson-Crick base-pairing. Microarrays are therefore a powerful tool for investigating the sequences and the quantity of sequences in incredibly complicated mixtures.

In general, fabrication of microarrays has been accomplished by direct deposition of pre-synthesized sequences or by in situ synthesis chemistries in which desired sequences are “grown” up from the microarray substrate surface. In situ synthesis is now massively parallel and can be achieved using a variety of methods, including ink-jet printing with standard reagents, photolabile 5′ protecting groups, photo-generated acid deprotection and electrolytic acid/base arrays. The resulting features or “spots” typically contain ˜1-10 million oligonucleotides of identical sequence, and the microarrays themselves are dense in features with up to tens of thousands of spots per cm2.

The melting temperature, Tm, for an oligonucleotide duplex is typically defined as the temperature at which half of a target is bound to its complement (probe) and half is unbound. While other factors contribute, for sequences of a given length, the purine or GC-content is the largest determining factor of Tm. A microarray containing very many sequences will necessarily represent a distribution of GC composition and therefore a distribution of Tms. For many microarray applications, both current and emerging, this results in a problematic compromise as to which probes can be included on any array that is to be hybridized isothermally, i.e. every probe at the same temperature.

In practice, probes included on an array for most applications are highly filtered for Tm. During the sequence selection of the probes to be included on a microarray, sequences having Tms that fall outside of a desired hybridization temperature range are simply discarded. Others have gone to great effort to design isothermal arrays of probes of varying length, however this raises other questions such as the effect of sterics. Probes of varying length will also be affected to varying degree by the effects of mismatches. Addition of compounds such as tetramethyl ammonium chloride (TMAC) that have a leveling effect on melting temperature can tighten the Tm range of a probe-set, but this practice is not a panacea. In addition to the toxicity of TMAC to experimentalists, ammonium compounds may react with trace free amine-reactive dyes often present in many protocols and thereby increase background signal. The addition of organic solvents such as formamide is intended to destabilize duplex formation such that hybridizations may be performed at more convenient, reduced temperatures. While kinetics may be altered by the inclusion of formamide, the addition results in only a linear shift in the predicted Tms and not a narrowing of the distribution itself.

### SUMMARY OF THE INVENTION

The present invention is directed to devices and methods for molecular association, particularly to devices and methods for facilitating hybridization of nucleic acids at multiple temperatures simultaneously and imaging thereof.

In one aspect, a molecular hybridization system generally includes a substrate having a plurality of molecular probes attached thereto. Molecular probes may generally include nucleic acid probes, peptide probes, aptamers, antibodies, and/or any other affinity binding probe and/or combinations thereof. The binding with some level of affinity between a molecular probe and a target molecule may generally be referred to as molecular association and/or hybridization, especially in the case of nucleic acids with at least some degree of complementarity. The plurality of probes may be generally present in multiple copies arranged in localized formations on the surface of the substrate. The molecular hybridization system further generally includes a chamber that encloses the plurality of molecular probes such that a fluid containing sample may be applied and kept in contact with the substrate having the probes thereon. The molecular hybridization system also includes a temperature affecting system that generally produces at least one desired temperature on the surface of the substrate and in the adjacent fluid within the chamber. The molecular hybridization system may also include a hybridization monitoring system, such as an optical monitoring system. In exemplary embodiments, the monitoring system may be real time.

The substrate may be generally planar and may be of any appropriate geometry such as, for example, rectangular, square, circular, elliptical, triangular, other polygonal shape, irregular and/or any other appropriate geometry. The plurality of molecular probes may also be arranged in any appropriate manner such as, for example, in circular or elliptical spots, square or rectangular spots, stripes, concentric rings and/or any other appropriate arrangement. The substrate may also be of other forms, such as cylindrical, spherical, irregular and/or any other appropriate form.

In an exemplary aspect of the present invention, a molecular hybridization system includes a system for producing a range of desired temperatures on the surface of the substrate and the adjacent fluid within the chamber. This may be particularly useful when employing a set of probes having a significant range of Tms. In one embodiment, the system includes a plurality of temperature affecting devices that are in thermal communication with the substrate. The plurality of devices may generally be disposed such that they may each produce a desired temperature in a given locality on the surface of the substrate. The set of probes may also be distributed on the surface of the substrate such that the temperature at the location of a molecular probe is substantially at the Tm of the molecular probe. Temperature affecting devices may be any appropriate device that may substantially produce a desired temperature on a substrate and may include, but are not limited to, thermoelectric devices such as Peltier junction devices, semiconductor heating devices, resistive heating devices, inductive heating devices, heating/cooling pumps, electromagnetic radiation sources and/or any other appropriate devices. Temperature may also be affected by other systems, such as, for example, fluid flows including, but not limited to, water flows, air flows, and/or any other appropriate fluid flows.

In an exemplary embodiment, a plurality of Peltier junction devices is utilized to generate desired temperatures at localities on the surface of the substrate. Peltier junction devices are particularly useful since they are able to both heat and cool using electrical current. This enables Peltier junction devices to generate temperatures above and below the ambient temperature of a system. They may also be useful in maintaining given temperature conditions at a steady state by adding and removing heat as necessary from the system.

In general, the placement of the temperature affecting devices may determine the temperature profile on the surface of the substrate and the adjacent fluid in the chamber. The temperature affecting devices may thus be disposed at appropriate positions such that given temperatures may be produced and maintained at known positions on the substrate.

The substrate may in general have a given thermal conductivity such that the application of at least one temperature affecting device may substantially generate a temperature gradient profile on the surface of the substrate. In general, the temperature on the surface of the substrate may change as a function of the distance from the position of the at least one temperature affecting device. Substrate materials with a relatively low thermal conductivity may generally produce highly localized temperature variations around a temperature affecting device. Substrate materials with a relatively high thermal conductivity may generally produce more gradual variations in temperature over a given distance from a temperature affecting device. It may be understood that at steady state, the effect of the thermal conductivity of the substrate may not contribute to the temperature profile of the system.

In some embodiments, at least one temperature affecting device may be utilized to produce a particular temperature gradient profile on the surface of the substrate. In general, a temperature gradient may be generated by utilizing at least one temperature affecting device producing a temperature different from the ambient temperature of the system. Multiple temperature affecting devices with at least two producing different temperatures may be utilized to generate a temperature gradient without reliance on the ambient temperature of the system.

The positions and temperatures of multiple temperature affecting devices may be utilized to calculate a resulting temperature gradient profile on the surface of a substrate using standard heat transfer equations. An algorithm may then be utilized to calculate the optimal positions and/or temperatures for a plurality of temperature affecting devices to produce a desired temperature gradient profile on the surface of a substrate. The algorithm may be, for example, applied using a computational assisting system, such as a computer and or other calculatory device. This may be performed to tailor a temperature gradient profile to a particular substrate with a known disposition of molecular probes of known and/or calculated Tm. Similarly, a set of molecular probes of known and/or calculated Tm may be arranged on a substrate based on a temperature gradient profile. This may be desirable as placement of a molecular probe at a given location on a substrate may be accomplished more easily than tailoring a temperature profile to pre-existing locations of molecular probes on a substrate. In general, a molecular probe may be disposed on the substrate at a temperature address within the temperature profile gradient. The temperature address may, for example, be substantially at the Tm of the molecular probe during operation of the molecular hybridization system, and/or any other appropriate temperature.

In another aspect, the molecular hybridization system includes an adjustable system for generating a temperature profile. The adjustable system generally includes a plurality of temperature affecting devices, each affecting the temperature at a particular location of a substrate. In one embodiment, each of the plurality of temperature affecting devices is movable within the molecular hybridization system such that the locations of the temperature effects may be controlled. In another embodiment, a plurality of temperature affecting devices is provided that may be individually utilized in any appropriate number and/or pattern to produce a desired temperature profile on the substrate. The temperature affecting devices may, for example, be mounted in a grid such that the temperature effects may be spatially controlled in a coordinate fashion. In some embodiments, the positioning and/or utilization of the temperature affecting devices, as described above, may be manually controlled.

In an exemplary aspect, the temperature affecting devices are coupled to a thermal module in contact with the substrate. Microarrays of molecular probes are typically generated on a glass substrate, which limits the flexibility of utilizing materials of different thermal conductivities to generate a temperature profile on the substrate. In some embodiments, the thermal module may be constructed of a material having a different thermal conductivity than the substrate. The thermal module may, for example, have a higher thermal conductivity than the substrate. This may be utilized, for example, to alter the temperature profile subjected on the substrate at a faster rate than manipulating the temperature profile on the substrate directly, as a higher thermal conductivity may allow heat to move at a faster rate to and/or from the thermal module. In some embodiments, the temperature affecting devices may also directly contact the substrate.

In some exemplary embodiments, the thermal module and/or substrate may include multiple thermal conductivities. The thermal module and/or substrate may, for example, include at least one region of one thermal conductivity and at least one region of another thermal conductivity. This may be utilized to generate more complex temperature profiles on the substrate and may also be utilized to reduce the number of temperature affecting devices used. In general, regions having a higher thermal conductivity may experience a smaller temperature drop across a given area than regions having a lower thermal conductivity.

In another exemplary aspect, the positioning and/or utilization of the temperature affecting devices are controlled automatically by a control system. The control system may, for example, be a computerized system that may control each individual temperature affecting device.

In some embodiments, the control system automatically controls the plurality of temperature affecting devices to produce a desired temperature profile on a substrate. The control system may, for example, calculate the temperature profile generated by the plurality of temperature affecting devices in relation to the properties of the substrate and/or fluid within the chamber. The calculation may be performed by any appropriate method such as, for example, finite element analysis, Fourier field analysis and/or any other appropriate method or combination thereof.

In general, the control system may generate a temperature profile such that the temperature at a particular location on the substrate substantially matches the Tm of the molecular probe(s) disposed at that location, and/or any other appropriate temperature.

The control system may also include optimization such that the control system may perform a best fit between the temperature profile and the disposition of molecular probes on the substrate.

In some embodiments, the control system also includes feedback control. The molecular hybridization system may, for example, include temperature sensors such that the actual temperature profile on the substrate may be observed. The temperature profile may then be adjusted utilizing the feedback from the temperature sensors by the control system. This may be done, for example, to compensate for variations between calculated and actual conditions.

In general, a molecular hybridization system may further utilize a circulation system within a chamber to increase the rate of diffusion of target molecules in a sample fluid to the molecular probes on the substrate. A circulation system may include, for example, a stirring mechanism, a centrifugation mechanism and/or any other appropriate circulation system. Passive circulation may also be utilized, such as circulation due to temperature gradients, which may include, for example, Rayleigh-Bernard instabilities, similar to lava lamp flows, which may arise when a temperature profile is oriented at least partially along a gravitational field such that a region of higher temperature may be located lower in a gravitational field than a region of lower temperature. Thus, heated fluid may rise to the region of lower temperature by virtue of lower density and then circulate back down as it cools and increases in density.

In exemplary aspects, a molecular hybridization system is utilized to facilitate hybridization of molecular probes disposed on a substrate and a sample. In exemplary embodiments, a molecular hybridization system is used to facilitate hybridization over a temperature range that simultaneously encompasses the Tm's of the molecular probes disposed on a substrate, wherein the molecular probes are disposed substantially at a location, or temperature address, at or near to its Tm. This may be desirable as hybridization for all molecular probes on the substrate may occur simultaneously at each molecular probe's Tm, which may aid in higher specificity of hybridization (e.g. aid in eliminating false positives/negatives due to differences between hybridization temperature and the Tm of a probe).

In some embodiments, the molecular hybridization system may receive an input of the disposition, composition and/or Tm of a set of molecular probes on a substrate from which the system may calculate and apply an appropriate temperature profile using a plurality of temperature affecting devices.

In other embodiments, a set of temperature profiles may be provided for use with the molecular hybridization system. The temperature profiles may, for example, provide a given distribution of temperature addresses for use with molecular probes. A substrate may then be prepared with a set of molecular probes disposed at appropriate locations such that the molecular probes may be located at temperature addresses substantially at their Tm.

In other exemplary aspects, a molecular hybridization system is utilized to simultaneously acquire melting curves for a set of molecular probes. Melting curves are typically derived in a temporal manner, wherein a molecular probe and its conjugate are heated over a temperature range to determine the level of hybridization across the range, the Tm of the molecular probe being typically defined as the temperature at which half the conjugate is hybridized to the molecular probe. This method, however, takes additional time as the molecular probe must be sequentially heated over a temperature range. In one embodiment, the set of molecular probes may be disposed on a substrate such that copies of each unique molecular probe are disposed at multiple locations on the substrate surface. The molecular hybridization system may then be utilized to produce substantially different temperatures at each location, as described above. An optical monitoring system, such as a digital camera, may be utilized to monitor the hybridization from, for example, the fluorescence emitted at each location. The acquired hybridization data may then be utilized to generate melting curves for the set of molecular probes, the resolution of the curve being generally defined by the number and disposition of each molecular probe on the surface of the substrate.

In yet another aspect, the molecular hybridization system may be utilized to perform hybridization-related procedures. In some embodiments, the molecular hybridization system may be utilized to perform a polymerase chain reaction (PCR) procedure. In other embodiments, sequencing procedures, such as Sanger sequencing or hybridization sequencing, may also be performed utilizing the molecular hybridization system.

In still another aspect, a method for performing affinity binding assays is provided that includes generating multiple copies of a molecular probe on a substrate, labeling said copies with an energy converting marker, providing at least partially binding molecules to the molecular probe labeled with a second energy converting marker, providing a sample which may contain a target which may bind to the molecular probe in competition with the labeled at least partially binding molecules, providing energy that may be converted by at least one of the energy converting markers, and detecting the energy converting response of at least one of the markers. In an exemplary embodiment, the markers are fluorescent molecules which may experience Fluorescence Resonance Energy Transfer (FRET) with each other when in substantial proximity.

The present invention together with the above and other advantages may best be understood from the following detailed description of the embodiments of the invention illustrated in the drawings.

### BRIEF DESCRIPTION OF THE FIGURES

FIG. 1 illustrates a substrate with a plurality of molecular probes;

FIG. 1a illustrates a molecular hybridization system with a substrate with a plurality of molecular probes enclosed in a chamber;

FIGS. 2, 2a and 2b illustrate examples of substrates;

FIGS. 3, 3a and 3b illustrate examples of molecular probe formations on a substrate;

FIGS. 4, 4a and 5 illustrate molecular hybridization systems with a plurality of temperature affecting devices;

FIGS. 6 and 6a illustrate examples of temperature profiles on a substrate generated by a plurality of temperature affecting devices;

FIG. 7 illustrates an embodiment of a molecular hybridization system with a one-dimensional temperature gradient;

FIGS. 8, 9 and 9a illustrate examples of molecular hybridization systems with an adjustable system of temperature affecting devices;

FIG. 10 illustrates a modular molecular hybridization system;

FIG. 11 illustrates a molecular hybridization system with an optical system;

FIGS. 12 and 12a illustrate examples of circulation systems;

FIG. 13 shows an example of a flow chart of a molecular hybridization system control system;

FIG. 14 shows a melting temperature distribution of a random set of oligonucleotide probes;

FIG. 15 shows a melting temperature distribution for a large, commercially marketed probe set of 70-mers which has been filtered for melting temperature;

FIG. 16 shows a histogram of temperature addresses on a microarray with temperatures controlled at the corners;

FIG. 17 illustrates heat transfer through a solid in one dimension;

FIG. 17a shows a set of common heat transfer equation solutions for a finite slab of material;

FIGS. 17b and 17c show an example of Rayleigh-Bernard driven convection;

FIGS. 18 and 18a show an example of a molecular hybridization system with a thermal module of multiple thermal conductivities;

FIG. 18b illustrates heat transfer through a solid of multiple thermal conductivities in one dimension;

FIGS. 18c and 18d show embodiments of thermal modules of multiple thermal conductivities;

FIGS. 19, 19a and 19b illustrate an embodiment of an annular molecular hybridization system;

FIGS. 20, 20a, 20b, 20c, 20d, 20e, 20f, 20g, and 20h illustrate an embodiment of an integrated molecular hybridization system;

FIGS. 21, 21a, and 21b illustrate an embodiment of a temperature control device; and

FIG. 22 illustrates a molecular hybridization assay utilizing interacting markers.

### DETAILED DESCRIPTION OF THE INVENTION

The detailed description set forth below is intended as a description of the presently exemplified device provided in accordance with aspects of the present invention and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

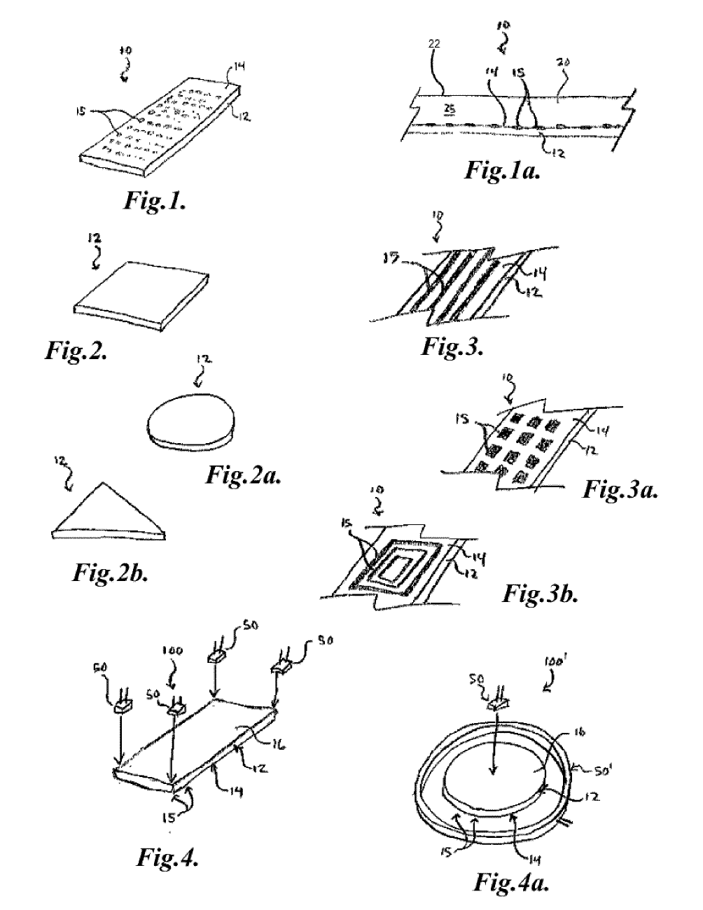

In one aspect, as illustrated in FIG. 1, a molecular hybridization system 10 generally includes a substrate 12 having a plurality of molecular probes attached thereto. The plurality of probes may be generally present in multiple copies arranged in localized formations 15 on the surface 14 of the substrate 12. The molecular hybridization system 10 further generally includes a chamber 20 formed between the substrate 12 and a second substrate or surface 22, as shown in FIG. 1a, that encloses the plurality of molecular probes 15 such that a fluid containing sample 25 may be applied and kept in contact with the substrate 12 having the probes thereon. The molecular hybridization system may also include a hybridization monitoring system, such as an optical monitoring system. In exemplary embodiments, the monitoring system may be real time.

In some embodiments, the substrate 12 may be generally planar and may be of any appropriate geometry such as, for example, rectangular, as shown in FIG. 1, square, as in FIG. 2, circular, as in FIG. 2a, elliptical, triangular, as in FIG. 2b, other polygonal shape, irregular and/or any other appropriate geometry. The plurality of molecular probes 15 may also be arranged in any appropriate manner such as, for example, in circular or elliptical spots, as shown in FIG. 1, stripes, as in FIG. 3, square or rectangular spots, as shown in FIG. 3a, concentric rings, as in FIG. 3b and/or any other appropriate arrangement.

In other embodiments, the substrate 12 may be of a non-planar form, such as, for example, cylindrical, spherical, irregular and/or any other appropriate form.

A molecular hybridization system 100 also includes a temperature affecting system that generally produces at least one desired temperature on the surface 14 of the substrate 12 and in the adjacent fluid 25 within the chamber 20.

In an exemplary aspect of the present invention, a molecular hybridization system 100 includes a system for producing a range of desired temperatures on the surface 14 of the substrate 12 and the adjacent fluid 25 within the chamber 20. This may be particularly useful when employing a set of probes having a significant range of Tms. In some embodiments, an example of which is illustrated in FIG. 4, the system includes a plurality of temperature affecting devices 50 that are in thermal communication with the substrate 12. The plurality of devices 50 may generally be disposed such that they may each produce a desired temperature in a given locality on the surface 14 of the substrate 12. The temperature affecting devices may be identical, such as shown in FIG. 4, or there may be multiple types of temperature affecting devices, such as shown with devices 50 and 50′ in FIG. 4a. The set of probes may also be distributed on the surface 14 of the substrate 12 such that the temperature at the location of a molecular probe is substantially at the Tm of the molecular probe. Temperature affecting devices 50 may be any appropriate device that may substantially produce a desired temperature on a substrate and may include, but are not limited to, thermoelectric devices such as Peltier junction devices, semiconductor heating devices, resistive heating devices, inductive heating devices, heating/cooling pumps, electromagnetic radiation sources and/or any other appropriate devices. Temperature may also be affected by other systems, such as, for example, fluid flows including, but not limited to, water flows, air flows, and/or any other appropriate fluid flows.

In an exemplary embodiment, a plurality of Peltier junction devices is utilized to generate desired temperatures at localities on the surface of the substrate 12. Peltier junction devices are particularly useful since they are able to either heat or cool using electrical current. This enables Peltier junction devices to generate temperatures above and below the ambient temperature of a system. They may also be useful in maintaining given temperature conditions at a steady state by adding and removing heat as necessary from the system.

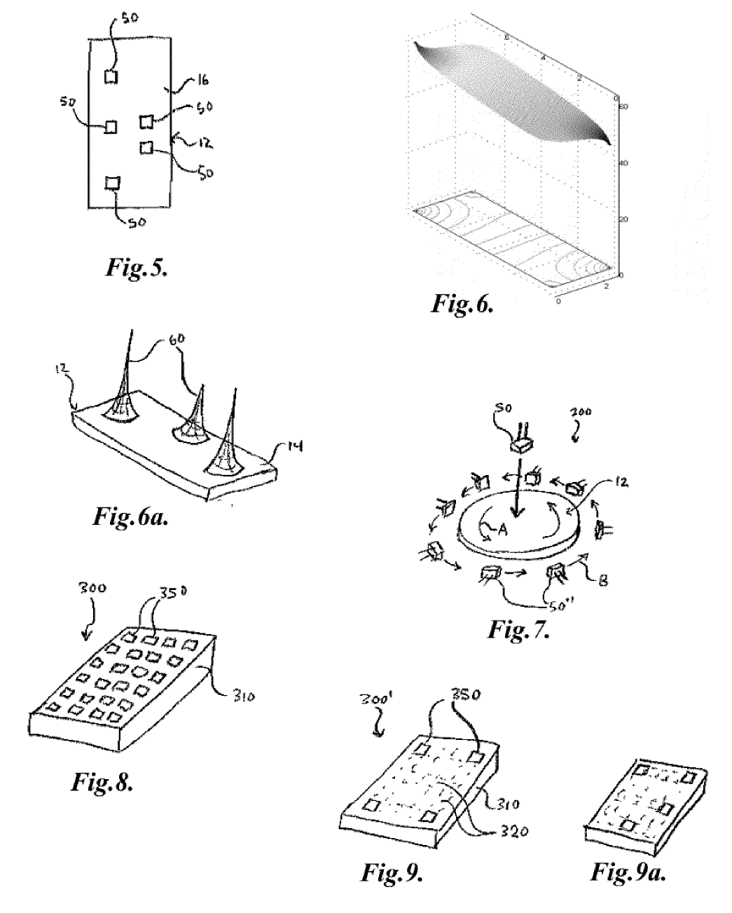

In general, the placement and operation of the temperature affecting devices 50 may determine the temperature profile on the surface 14 of the substrate 12 and the adjacent fluid 25 in the chamber 20. The temperature affecting devices 50 may thus be disposed at appropriate positions, examples of which are shown in FIGS. 4, 4a and 5, such that given temperatures may be produced and maintained at known positions on the substrate 12.

The substrate 12 may in general have a given thermal conductivity such that the application of at least one temperature affecting device 50 may substantially generate a temperature gradient profile on the surface of the substrate. In general, the temperature on the surface 14 of the substrate 12 may change as a function of the distance from the position of the at least one temperature affecting device 50. Substrate materials with a relatively low thermal conductivity may generally produce highly localized temperature variations around a temperature affecting device. Substrate materials with a relatively high thermal conductivity may generally produce more gradual variations in temperature over a given distance from a temperature affecting device 50. It may be appreciated that at steady state, the differences in thermal conductivity generally may not affect the temperature profile, since at steady state the temperature profile may be determined by the steady state temperature boundary values.

In some embodiments, at least one temperature affecting device 50 may be utilized to produce a particular temperature gradient profile on the surface 14 of the substrate 12. Examples of possible temperature gradients are shown in FIGS. 6 and 6a, FIG. 6 showing a more gradual variance in temperature across the surface, which may be accomplished with a substrate material of a higher thermal conductivity and FIG. 6a showing temperature spikes 60, which may be accomplished with a substrate material of a lower thermal conductivity.

In general, a temperature gradient may be generated by utilizing at least one temperature affecting device 50 producing a temperature different from the ambient temperature of the system. Multiple temperature affecting devices 50 with at least two producing different temperatures may be utilized to generate a temperature gradient without reliance on the ambient temperature of the system.

The positions and temperatures of multiple temperature affecting devices 50 may be utilized to calculate a resulting temperature gradient profile on the surface 14 of a substrate 12 using standard heat transfer equations.

In the general case for solids, the thermal conductivity, k, may be substantially constant for a given material. Thus for solids:

$$ρ {C}_{p} \frac{\partial T}{\partial t} = k {∇}^{2} T , \qquad ( eq . 1 )$$

where the ∇², or Laplacian operator in rectangular coordinates is:

$${∇}^{2} = \frac{{\partial }^{2}}{\partial {x}^{2}} + \frac{{\partial }^{2}}{\partial {y}^{2}} + \frac{{\partial }^{2}}{\partial {z}^{2}} . \qquad ( eq . 2 )$$

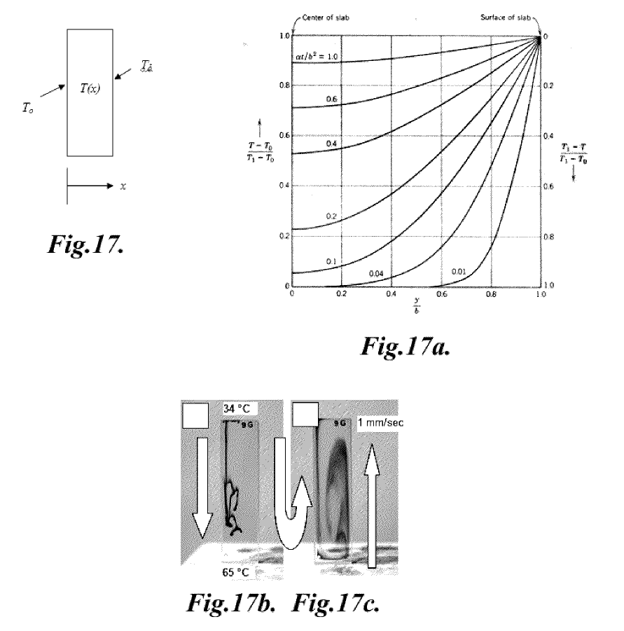

Considering only one dimension, x, as shown in FIG. 17, at steady state,

$$\frac{\partial T}{\partial t} = 0 ,$$

the equation of energy, eq. 1, reduces to

$$\frac{{d}^{2} T}{d {x}^{2}} = 0 ,$$

which may be directly integrated using known boundary temperatures to give the temperature in the solid as a function of x, T(x):

$$\frac{T ( x ) - {T}_{o}}{{T}_{δ} - {T}_{o}} = \frac{x}{δ} . \qquad ( eq . 3 )$$

The temperature in a two-dimensional domain is defined by the solution of:

$$\frac{{\partial }^{2} T}{\partial {x}^{2}} + \frac{{\partial }^{2} T}{\partial {y}^{2}} = 0 ,$$

the analytical solution of which may be obtained by methods of complex analysis (e.g. Cauchy-Reimann transform). Methods of numerical analysis, such as methods of finite differences and/or finite element analysis, may be used to solve the temperature gradients applied by the molecular hybridization system.

In embodiments which may include multiple regions of different thermal conductivity, at steady-state, the temperature gradients across the regions may be a result of their respective material properties, e.g. the thermal diffusivity, α defined as

$$\frac{k}{ρ {C}_{p}} .$$

In one example, the temperatures of the temperature affecting devices generating a gradient may be considered at steady-state. However, for certain embodiments, the unsteady-state heat equation, eq. 1, may also be solved by methods of finite difference analysis, finite element analysis and/or any other appropriate method. For example, in one dimension, the solution to the equation:

$$ρ {C}_{p} \frac{\partial T}{\partial t} = k \frac{{\partial }^{2} T}{\partial {x}^{2}} , \qquad ( eq . 4 )$$

is a Fourier series:

$$T ( x , t ) = \frac{4}{π} {\sum }_{n = 0}^{∞} \frac{sin [ ( 2 n + 1 ) π x}{( 2 n + 1 )} exp \{ - {( 2 n + 1 )}^{2} {π}^{2} t \} .$$

More generally, the equation,

$$\frac{\partial T}{\partial t} = α {∇}^{2} T \qquad ( eq . 5 )$$

may be solved, for example, by consulting an appropriate solution reference, such as for the time-dependent heating of a finite slab is shown in FIG. 17a.

An algorithm may then be utilized to calculate the optimal positions and temperatures for a plurality of temperature affecting devices 50 to produce a desired temperature gradient profile on the surface 14 of a substrate 12. This may be done to tailor a temperature gradient profile to a particular substrate 12 with a known disposition of molecular probes of known and/or calculated Tm. Similarly, a set of molecular probes of known and/or calculated Tm may be arranged on a substrate 12 based on a temperature gradient profile. This may be desirable as placement of a molecular probe at a given location on a substrate 12 may be accomplished more easily than tailoring a temperature profile to pre-existing locations of molecular probes on a substrate 12. In general, a molecular probe may be disposed on the substrate 12 at a temperature address within the temperature profile gradient. The temperature address may, for example, be substantially at the Tm of the molecular probe. The algorithm may be, for example, applied using a computational assisting system, such as a computer.

In another embodiment, temperature affecting devices may be utilized to create a one dimensional temperature gradient. FIG. 7 illustrates an embodiment of a molecular hybridization system 200 with a circular substrate 12. A temperature affecting device 50 may be disposed to generate a temperature at the center of the circular substrate 12 while at least one temperature affecting device 50″ may be located at the edge of the circular substrate 12. The at least one temperature affecting device 50″ may be moved around B the edge of the circular substrate 12 such that the edge is maintained at substantially a single temperature. Alternatively, the circular substrate 12 may be rotated A or both the circular substrate 12 and the at least one temperature affecting device 50″ may move. In general, the movement of either the circular substrate 12 and/or the at least one temperature affecting device 50″ may be utilized to aid in evening out the temperature at the edge of the circular substrate 12. It may also be appreciated that more temperature affecting devices 50″ may increase the evening out of the temperature at edge of the circular substrate 12. A one dimensional temperature gradient may then be generated by holding the temperature affecting device 50 at one temperature and the at least one temperature affecting device 50″ at another temperature, the temperature gradient being one dimensional due to the symmetry of the system.

In another aspect, the molecular hybridization system includes an adjustable system for generating a temperature profile. FIG. 8 illustrates an embodiment of a molecular hybridization system 300 with an adjustable system 310. The adjustable system 310 generally includes a plurality of temperature affecting devices 350, each affecting the temperature at a particular location of a substrate. The plurality of temperature affecting devices 350 may be individually utilized in any appropriate number and/or pattern to produce a desired temperature profile on the substrate. The temperature affecting devices 350 may, for example, be mounted in a grid such that the temperature effects may be spatially controlled in a coordinate fashion. In some embodiments, the positioning and/or utilization of the temperature affecting devices 350, as described above, may be manually controlled.

In another embodiment, as shown in FIGS. 9 and 9a, each of the plurality of temperature affecting devices 350 is movable within the adjustable system 310 of molecular hybridization system 300′ such that the locations of the temperature effects may be controlled. The plurality of temperature affecting devices 350 may, for example, be moved within a series of tracks 320 in the adjustable system 310.

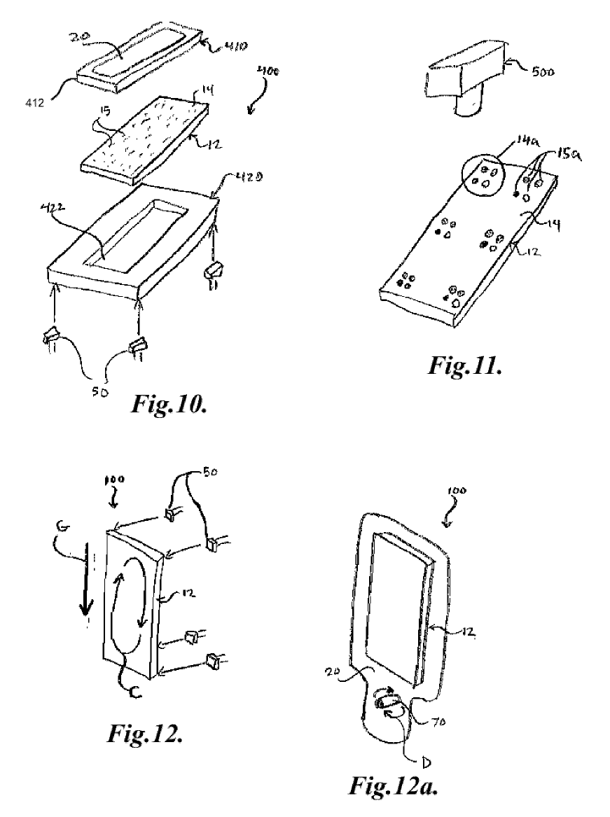

In some embodiments, the molecular hybridization system may be modular such that the system may be easily reused. A molecular hybridization system 400 may include, for example, a thermal module 420 for thermally coupling temperature affecting devices 50 to a substrate 12 via a holding portion 422, and an enclosure 410 for defining a chamber 20, as illustrated in FIG. 10. The thermal module 420 and the temperature affecting devices 50 may generally be reusable with different substrates 12 with molecular probes 15. The enclosure 410 may either be reusable or replaced for each procedure. The enclosure 410 may also include at least one sealing member 412 to aid in preventing leakage from the chamber 20.

In an exemplary aspect, the temperature affecting devices 50 are coupled to a thermal module in contact with the substrate 12, the thermal module having a different thermal conductivity than the substrate 12. Microarrays of molecular probes are typically generated on a glass substrate, which limits the flexibility of utilizing materials of different thermal conductivities to generate a temperature profile on the substrate. In some embodiments, a thermal module 420 may be utilized. The thermal module 420 may be constructed of a material having a different thermal conductivity than the substrate 12. The thermal module 420 may, for example, have a higher thermal conductivity than the substrate 12. This may be utilized, for example, to alter the temperature profile subjected on the substrate 12 at a faster rate than manipulating the temperature profile on the substrate 12 directly, as a higher thermal conductivity may allow heat to move at a faster rate to and/or from the thermal module 420.

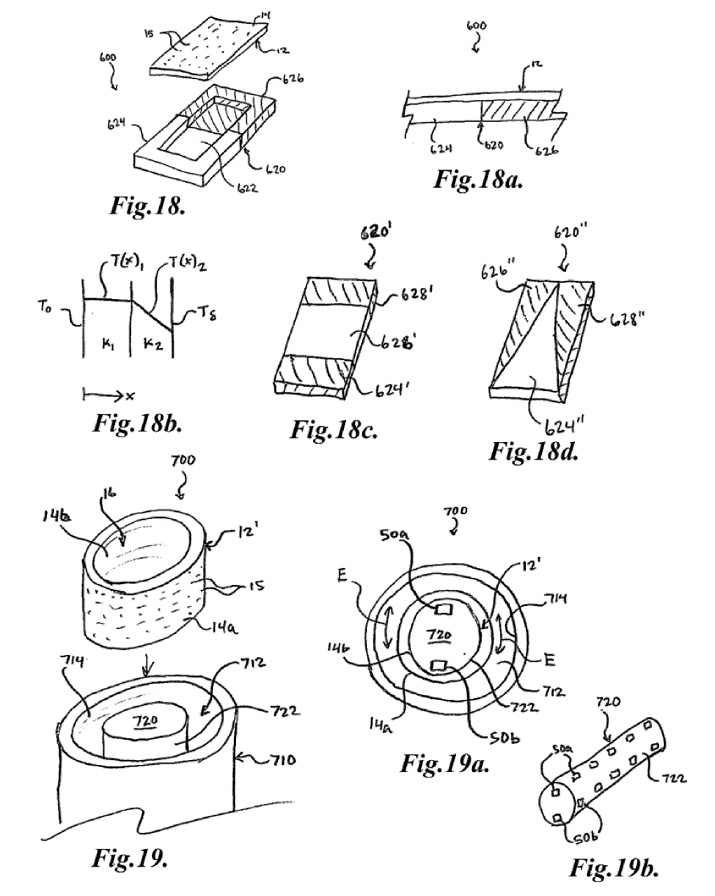

In some exemplary embodiments, the thermal module and/or substrate may include multiple thermal conductivities. A thermal module and/or substrate may include at least one region of one thermal conductivity and at least one region of another thermal conductivity, an example of which is shown with thermal module 620 of molecular hybridization system 600 in FIG. 18. This may be utilized to generate more complex temperature profiles on the substrate 12 and may also be utilized to reduce the number of temperature affecting devices used. For example, a temperature affecting device may be coupled to a region having a high thermal conductivity, which in a thermal module having multiple regions of different thermal conductivities, may be maintained at substantially the same temperature as the temperature affecting device. In general, regions having a higher thermal conductivity may experience a smaller temperature drop across a given area than regions having a lower thermal conductivity.

A thermal module 620 may, in some embodiments, have multiple regions of different thermal conductivities, as shown with regions 624, 626 in FIGS. 18 and 18a. A given location on the substrate 12 may be generally at substantially the same temperature as a given location the thermal module 620 that it contacts. In a one dimensional case, as shown with temperature profiles T(×)1 and T(×)2 in FIG. 18b, a temperature drop from a high temperature T0 across a region with a higher thermal conductivity k1 may be smaller that across a region with a lower thermal conductivity k2. A thermal module may also have additional regions, such as, for example, regions 624′, 626′, 628′ of thermal module 620′ in FIG. 18c, regions 624″, 626″, 628″ of thermal module 620″ in FIG. 18d, and/or any other appropriate number and/or disposition of regions. In general, the size, shape, arrangement and/or thermal conductivities of a set of regions of a thermal module may be designed to produce particular temperature profiles in conjunction with temperature affecting devices. Complex temperature profiles may thus be applied to accommodate particular collections of molecular probes having a range of Tm's.

In another aspect, a molecular hybridization system is utilized to simultaneously acquire melting curves for a set of molecular probes. In one embodiment, as illustrated in FIG. 11, a set of molecular probes 15a may be disposed on a substrate 12 such that copies of each unique molecular probe 15a are disposed at multiple locations 14a on the substrate surface 14. The molecular hybridization system may then be utilized to produce substantially different temperatures at each location, as described above. An optical monitoring system 500, such as a digital camera, may be utilized to monitor the hybridization from, for example, the fluorescence emitted at each location 14a. The acquired hybridization data may then be utilized to generate melting curves for the set of molecular probes 15a, the resolution of the curve being generally defined by the number and disposition of each molecular probe on the surface 14 of the substrate 12. Other optical monitoring devices may also be utilized, such as a scanner, non-imaging mapping device, and/or any other appropriate optical monitoring device. Resolution for small deposits of molecular probes may also be improved by, for example, coupling each individual deposit or “spot” to a single sensor element or group of elements, such as a the pixels of a digital sensor. The coupling may be accomplished by any appropriate method, such as, for example, by utilizing focusing, optical tapers, optical fibers, and/or any other appropriate method.

In general, a molecular hybridization system 100 may further utilize a circulation system within a chamber to increase the rate of diffusion of target molecules in a sample fluid to the molecular probes on the substrate. A circulation system may include, for example, a stirring mechanism, a centrifugation mechanism and/or any other appropriate circulation system. Passive circulation may also be utilized, such as circulation due to temperature gradients, which may include, for example, Rayleigh-Bernard instabilities, similar to lava lamp flows, which may arise when a temperature profile is oriented at least partially along a gravitational field such that a region of higher temperature may be located lower in a gravitational field than a region of lower temperature. Thus, heated fluid may rise to the region of lower temperature by virtue of lower density and then circulate back down as it cools and increases in density.

Passive circulation may be utilized, as illustrated in FIG. 12, such as circulation C due to a temperature gradient generated by a plurality of temperature affecting devices 50, as described above, and a gravitational field G. A circulation system may also include, for example, a stirring mechanism 70, such as a magnetic stirrer illustrated in FIG. 12a, which may be rotated to create circulation in chamber 20 by a magnetic force D. Other circulation systems may also include, but are not limited to, stirrers and/or agitators, magnetic pellets moving in a magnetic field, sonic/ultrasonic vibrators and/or any other appropriate circulation system. Also, a chamber 20 may be designed to optimize convection and/or mixing. The chamber 20 may also be designed to aid in eliminating “dead spots”, or regions with little or no circulation.

In some embodiments, a generally annular molecular hybridization system 700 may be utilized, an example of which is shown in FIGS. 19, 19a and 19b. A substrate 12′ may be utilized, the substrate 12′ having a generally annular form which may include a outer surface 14a and an inner surface 14b about a channel 16. A plurality of molecular probes 15 may be disposed on the outer surface 14a. The substrate 12′ may be housed in a bore 712 of hybridization chamber 710. The bore 712 may further contain a temperature affecting rod 720, the surface 722 of which may be in contact with the inner surface 14b of substrate 12′. The temperature affecting rod 720 may include a plurality of temperature affecting devices 50a, 50b. The temperature affecting devices 50a, 50b may be disposed in any appropriate configuration and may generally be disposed to generate at least one temperature gradient across the rod 720. The molecular hybridization system 700 may be of any suitable annular form, which may include, but is not limited to, cylindrical, elliptic cylindrical, rectangular prismatic and/or any other suitable annular form. The temperature gradient may also cause a sample containing fluid within bore 712 to circulate E similar to density differences at different temperatures. It may be appreciated that the fluid may begin to circulate in a single dominant direction.

In an exemplary aspect, the positioning and/or utilization of the temperature affecting devices are controlled automatically by a control system. The control system may, for example, be a computerized system that may control each individual temperature affecting device.

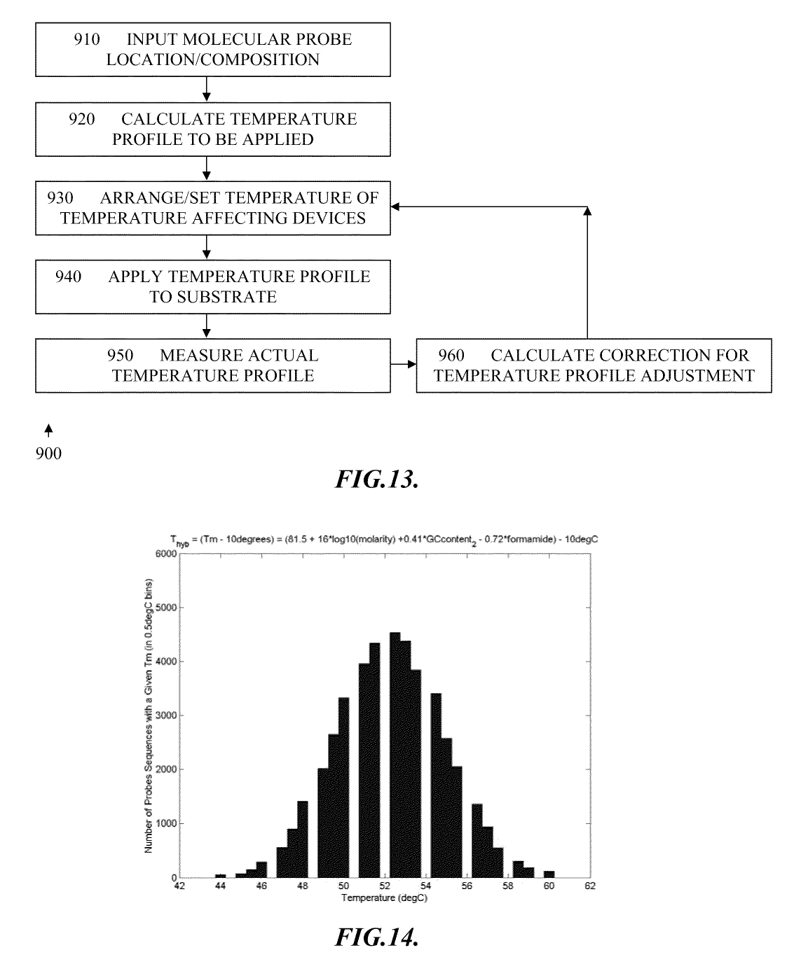

In some embodiments, the control system automatically controls the plurality of temperature affecting devices to produce a desired temperature profile on a substrate. FIG. 13 shows an example of a flow chart of a control system 600 for a hybridization procedure. The control system 600 may, for example, accept an input 610 of the positions and compositions of a set of molecular probes on a substrate and perform a calculation 620 of the temperature profile generated by the plurality of temperature affecting devices in relation to the properties of the substrate and/or fluid within the chamber. The calculation may be performed by any appropriate method such as, for example, finite element analysis, Fourier field analysis and/or any other appropriate method or combination thereof.

In general, the control system may generate a temperature profile such that the temperature at a particular location on the substrate substantially matches the Tm of the molecular probe(s) disposed at that location.

The control system 900 may also include optimization such that the control system 900 may perform a best fit between the temperature profile and the disposition of molecular probes on the substrate as part of the temperature profile calculation 920. The control system 900 may then perform an arrangement/setting 930 of the locations, if adjustable, and/or the temperatures produced by the temperature affecting devices to generate the desired temperature profile. The control system 900 may then start the application 940 of the temperature profile to the substrate to begin a hybridization procedure.

In some embodiments, the control system 900 also includes feedback control. The molecular hybridization system may, for example, include temperature sensing such that the actual temperature profile on the substrate may be observed and measured, such as at a measuring step 950. Temperature sensing may include, for example, temperature sensors such as thermocouples, thermal imaging, imaging of a fluoroptic or calorimetric thermal reporting layer, and/or any other appropriate temperature sensing. The temperature profile may then be adjusted utilizing the feedback from the temperature sensors by the control system 900. This may be done, for example, to compensate for variations between calculated and actual conditions. A calculation 960 may be performed to adjust the settings of the arrangement/setting 930 of the temperature affecting devices. This feedback of steps 930, 940, 950, 960 may be performed continuously to attain and maintain a desired temperature profile on the substrate.

In exemplary aspects, a molecular hybridization system is utilized to facilitate hybridization of molecular probes disposed on a substrate and a sample. In exemplary embodiments, a molecular hybridization system is used to facilitate hybridization over a temperature range that simultaneously encompasses the Tm's of the molecular probes disposed on a substrate, wherein the molecular probes are disposed substantially at a location, or temperature address, at or near to its Tm. This may be desirable as hybridization for all molecular probes on the substrate may occur simultaneously at each molecular probe's Tm, which may aid in higher specificity of hybridization (e.g. aid in eliminating false positives/negatives due to differences between hybridization temperature and the Tm of a probe).

In some embodiments, the molecular hybridization system may receive an input of the disposition, composition and/or Tm of a set of molecular probes on a substrate from which the system may calculate and apply an appropriate temperature profile using a plurality of temperature affecting devices.

In other embodiments, a set of temperature profiles may be provided for use with the molecular hybridization system. The temperature profiles may, for example, provide a given distribution of temperature addresses for use with molecular probes. A substrate may then be prepared with a set of molecular probes disposed at appropriate locations such that the molecular probes may be located at temperature addresses substantially at their Tm.

In yet another aspect, the molecular hybridization system may be utilized to perform hybridization-related procedures. In some embodiments, the molecular hybridization system may be utilized to perform a polymerase chain reaction (PCR) procedure. The temperature may be temporally varied to melt the DNA to separate strands and then annealed at an appropriate temperature using a temperature profile as discussed above. In other embodiments, sequencing procedures, such as Sanger sequencing or hybridization sequencing, may also be performed utilizing the molecular hybridization system.

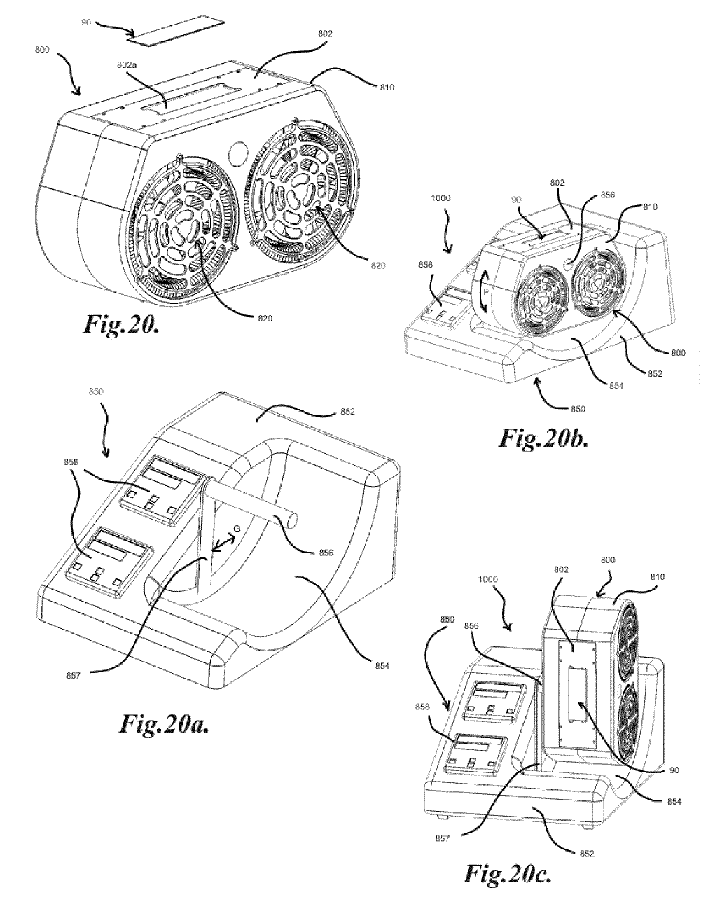

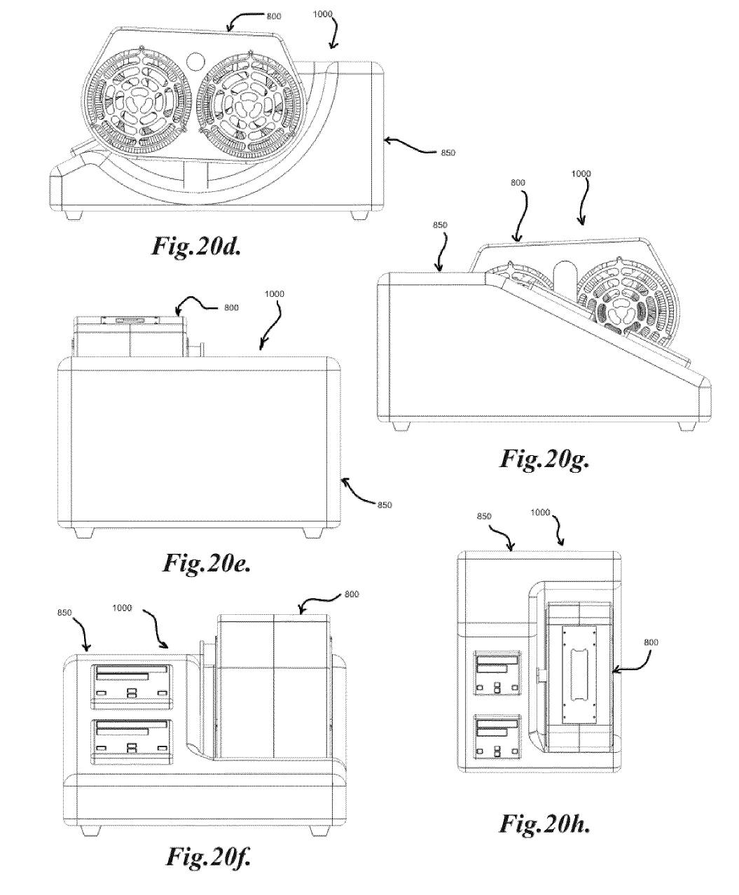

An exemplary embodiment of an integrated molecular hybridization system 1000 is illustrated in FIGS. 20, 20a, 20b, and 20c. FIG. 20 shows a binding module 90, which may generally include a substrate with a plurality of molecular probes disposed thereon, and an enclosed chamber containing a target-bearing fluid, such as discussed above. The binding module 90 may be disposed on a temperature controlling device, such as the exemplary temperature control device 800 shown in FIG. 20. The temperature control device 800 may generally retain the binding module 90 and affect a desired temperature profile, as discussed above. The temperature control device 800 may include a thermal module 802, which may further have a receptacle 802a for the binding module 90. The thermal module 802 may generally facilitate heat transfer between the binding module 90 and at least one temperature affecting device, as described above. The temperature control device 800 may further include a housing 810 which may house and/or retain at least one temperature control module 820 which may be utilized to affect the temperature of at least one portion of the binding module 90.

The integrated molecular hybridization system 1000 may further include an interface control module 850, as shown in FIG. 20a. The interface control module 850 may generally control and operate the temperature control device 800, such as by, for example, providing power to, controlling the temperature profile generated by, and providing a user interface for the temperature control device 800. The interface control module 850 may include a housing 852, a temperature control module retainer 854, and controls and displays 858. In one embodiment, the interface control module 850 may also control the spatial orientation of the temperature control device 800 such that the spatial orientation of the binding module 90 may be affected. The interface control module 850 may then include a temperature control module holder 856 which may be mounted on a control arm 857. The temperature control device 800 may thus mount onto the interface control module 850 via the holder 856. The temperature control device 800 may then be shifted F between a substantially horizontal orientation, as shown in FIG. 20b, and a substantially vertical orientation, as shown in FIG. 20c, and/or any orientation between. This may be particularly desirable to take advantage of Rayleigh-Bernard driven convection, as discussed above. In one exemplary embodiment, the control arm 857 may translate G. The temperature control device housing 810 may then slide along the retainer 854, rotating about the holder 856 and biasing against the retainer 854 to change orientation. In other embodiments, a motor may be utilized to rotate the temperature control device 800 about the holder 856.

An exemplary embodiment of an integrated molecular hybridization system 1000, including a temperature control device 800 and interface control module 850, is further illustrated in the right side view of FIG. 20d, back view of FIG. 20e, front view of FIG. 20f, left side view of FIG. 20g, and the top view of FIG. 20h.

It may be appreciated that the components of the integrated molecular hybridization system 1000 and the dispositions thereof may be included, arranged and/or disposed in alternate configurations without departing from the spirit of the invention.

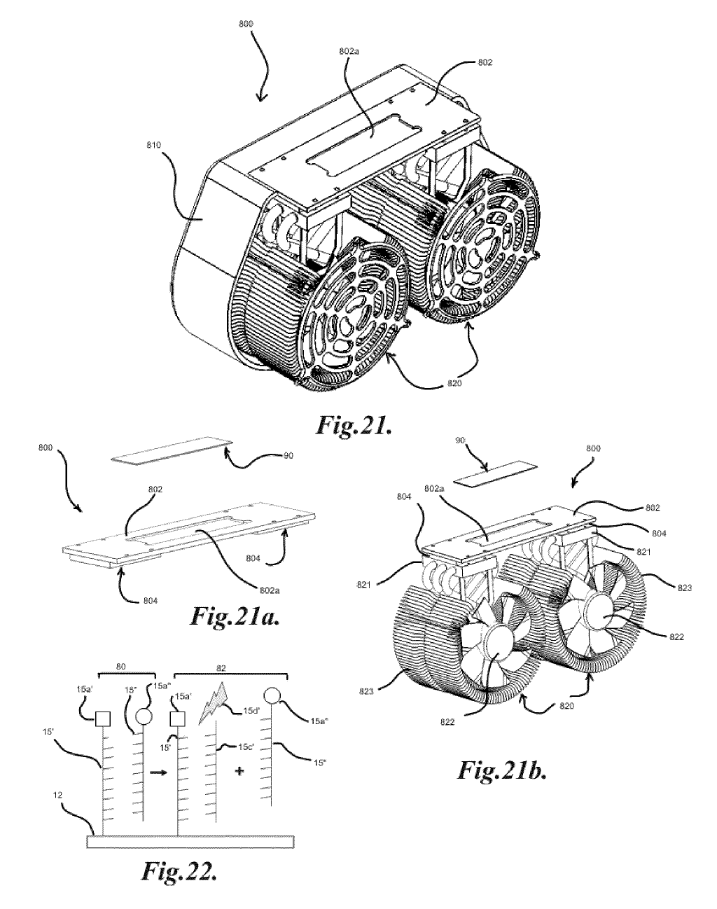

FIGS. 21, 21a and 21b illustrate an exemplary embodiment of the temperature control device 800. FIG. 21 shows a partial cutaway view of the temperature control device 800 with a binding module 90, including a thermal module 802 with a binding module retainer 802a, at least one temperature control module 820 within the housing 810. The thermal module 802 may be coupled to at least one temperature affecting device 804, an example of which is shown in FIG. 21a, in a spatial manner such as discussed above, such that a temperature profile may be applied to the thermal module 802 and thus the substrate of the binding module 90. FIG. 21b further illustrates an embodiment of a temperature control device 800 including cooling assemblies for removing heat from the temperature affecting devices 804 and/or the temperature control device 800 as a whole. For example, a cooling assembly may include heat sinks 821 which may be in thermal contact with the temperature affecting devices 804. The heat sinks 821 may further couple to other cooling devices, such as large surface area cooling structures 823, and/or fans 822. It may be appreciated that cooling assemblies may include any of the above components, combinations thereof, and/or any other appropriate cooling components or devices, and/or combinations thereof.

In still another aspect, a method for performing affinity binding assays is provided, an exemplary embodiment of which is illustrated in FIG. 22. In general, the method includes generating multiple copies of a molecular probe 15′ on a substrate 12, labeling said copies with an energy converting marker 15a′, providing at least partially binding molecules 15″ to the molecular probe 15′ labeled with a second energy converting marker 15a″, providing a sample which may contain a target 15c′ which may bind to the molecular probe 15′ in competition with the labeled at least partially binding molecules 15″, providing energy that may be converted by at least one of the energy converting markers 15a′, 15a″, and detecting the energy converting response 15d′ of at least one of the markers. The molecular probes may be synthesized separately or they may be synthesized directly on the substrate. In an exemplary embodiment, the markers are fluorescent molecules which may experience Fluorescence Resonance Energy Transfer (FRET) with each other when in substantial proximity. In FIG. 22, the energy converting markers 15a′, 15a″ may be fluorescent molecules with a quenching overlap such that when in proximity, as shown in step 80, FRET occurs between the markers 15a′, 15a″, resulting in one of the markers 15a′, 15a″ emitting less fluorescence upon excitation than would occur in the absence of the other marker. Upon addition of target 15c′, at least some of the molecule 15″ may be competed off from binding to molecular probe 15′, as shown in step 82, which may increase the distance between the markers 15a′, 15a″, which may decrease FRET. The differences in fluorescence may then correlate to the amount of bound target 15c′ in a “lights-on” fashion. Any appropriate FRET-capable marker pairs may be utilized, such as, for example, cy5 and Iowa Black-RP-sq (available from Integrated DNA Technologies). This method may be particularly desirable as the usual methodology of labeling target is more expensive, time-consuming and cannot be performed prior to acquiring sample. The molecular probe-binding molecule pairs may also be designed with altered binding affinity, such as with nucleic acid hybridization mismatches, to, for example, optimize the assay. This method may further be utilized to acquire melting curves for the molecular probes utilized via the temperature profile system as discussed above.

### EXAMPLE 1

To simulate the typical Tm distribution for a large, randomized probe-set, a MATLAB program was written to randomly choose 44,000 compositions of 60-mer probes. These numbers were chosen in accordance with the microarray format sold by Agilent Technologies. The MATLAB script allows the user to choose a salt and formamide concentration for use with commonly used melting equations. The program also has the ability to bias the use of G and C versus A and T. The predicted Tm's had a binomial distribution, as shown in FIG. 14. In comparison to randomly selected compositions, FIG. 15 shows the melting temperature distribution for a large, commercially marketed probe set of 70-mers which has been filtered for Tm.

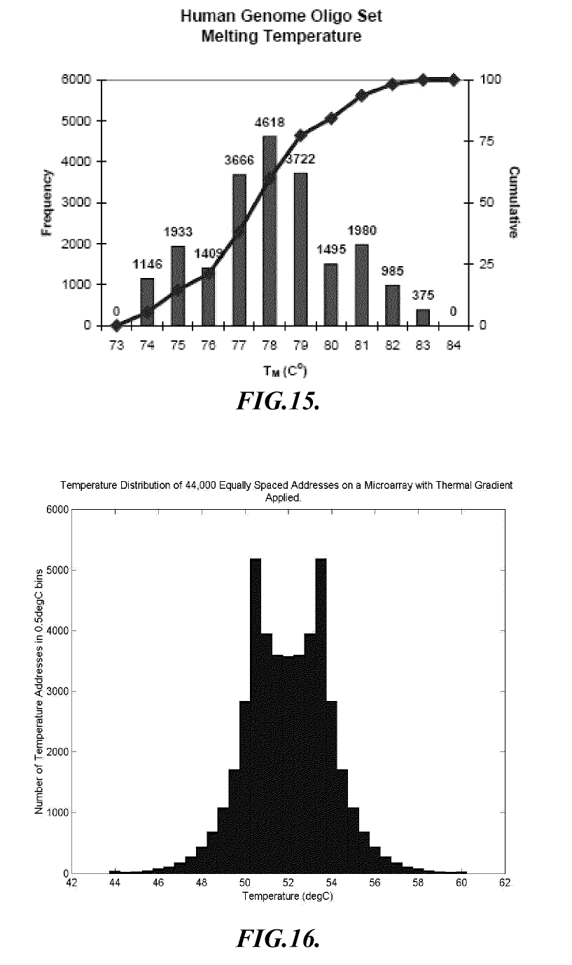

To simulate such a physical situation, the two-dimensional, steady-state heat conduction equations were solved in FEMLAB, a finite-element package integrated with MATLAB. A 1 inch×3 inch domain with a small subregion in each corner was drawn in 2D and the region was given the properties of borofloat glass. The ideal situation was assumed in which no heat loss to the ambient surroundings was assumed; the calculation was performed for a glass slide in air, but similar temperature gradients can be easily achieved with little heat applied or removed from objects of similar thermal mass containing liquids under convective flows. The temperature of each corner of the modeled slide could thereby be specified as a time-invariant boundary condition. FIG. 6 shows an example of a useful temperature profile which results when one corner is set to a distribution-maximum, Tm,max (in this case 60° C.), one corner set to a minimum Tm,min (44° C.) and two corners set to the average Tm,avg (52° C.) for a predicted melting temperature distribution. The resulting temperature profile data were then extracted from the program as equally spaced points (121×364) to match the 44,000 sequence addresses that would be present on a high density commercial array. FIG. 16 shows a histogram of the temperatures for each of the equally spaced points or “temperature addresses”. As can be seen, the tails of the distribution closely approximate a normal distribution. The bimodal peaks are a result of the two quarter-circle isotherms on the microarray slide. The presented temperature distribution represents a major improvement over an isothermal array substrate. Both the Tmin and Tmax tails of the distribution are captured and the large number of addresses on the array within the bimodal peaks would be less than 1.5° C. away from Tavg (42° C.) in this case.

### EXAMPLE 2

Various microarray providers recommend a number of mixing conditions during hybridization. Some protocols rely on an air-liquid interface for “bubble mixing”, and others rely on active pumping through a closed “chip” design. An alternative approach based upon temperature and gravity induced convection may prove superior in terms of both simplicity and compatibility with real time imaging. Rayleigh-Bernard flows (commonly observed in “lava lamps”) arise as a natural consequence of buoyancy driven instabilities that occur when a fluid is subjected to a temperature gradient. FIGS. 17b and 17c show the active convection induced by a 30° C. thermal gradient from the bottom to the top of a 1 mm quartz cuvette containing water and a small initial bolus of food coloring. Images were acquired at different times from several different experiments for best visualization of the typical flow. The inner face of one side of the quartz cuvette is meant to simulate the array surface. A characteristic velocity of ˜1 mm/sec was observed and target DNA may thus travel the length of the array approximately every 40 seconds.

It will be appreciated by those of ordinary skill in the art that the present invention can be embodied in other specific forms without departing from the spirit or essential character hereof. The present description is therefore considered in all respects to be illustrative and not restrictive. The scope of the present invention is indicated by the appended claims, and all changes that come within the meaning and range of equivalents thereof are intended to be embraced therein.

1. A system for facilitating molecular association comprising:
a first substrate having an array of spots comprising biological material coupled to the substrate;
a second substrate separated from the first substrate by a predetermined distance, said first and second substrates defining a chamber to enclose a fluid; and
a plurality of temperature affecting devices in thermal communication with said first substrate;
wherein each of said plurality of temperature affecting devices provide at least one adjustable temperature to said first substrate and are disposed to create a temperature gradient profile along a surface of said first substrate.

2. The system of claim 1 wherein the plurality of temperature affecting devices disposed at the boundaries of said first substrate.

3. The system of claim 2 wherein said first substrate comprises a rectangular surface and said plurality of energy sources are disposed at the corners of said first substrate.

4. The system of claim 1 further comprising a thermal module between said plurality of temperature affecting devices and said first substrate.

5. The system of claim 1, further comprising a cooling system.

6. The system of claim 1 wherein the temperature affecting devices are Peltier effect devices.

7. The system of claim 1 further comprising a circulation system.

8. The system of claim 7 wherein said circulation system comprises a magnetic stirrer.

9. The system of claim 7 wherein said circulation system comprises a temperature gradient oriented substantially along a gravitational field.

10. The system of claim 1 further comprising at least one controller, said at least one controller being adapted to adjust the temperature of said plurality of temperature affecting devices to generate a desired temperature gradient profile.

11. The system of claim 10 wherein said at least one controller comprises at least one sensing device and microprocessor.

12. A method for diagnostic molecular association of a sample comprising:
disposing a fluid containing a sample for molecular association between a first and second substrate, said first substrate having an array of spots comprising biological material coupled to the substrate and said second substrate separated from the first substrate by a predetermined distance, said fluid occupying a chamber defined by said first and second substrates; and
applying energy to said first substrate with a plurality of temperature affecting devices coupled to said first substrate, each of said temperature affecting devices sources providing at least one adjustable temperature to said first substrate and being disposed to create a temperature gradient profile along a surface of said first substrate;
whereby said temperature gradient profile enhances molecular association between molecules in said sample and a particular biological material coupled to said first substrate.

13. The method of claim 12 wherein said molecular association is a hybridization process.

14. The method of claim 12 wherein said array of spots are disposed to substantially optimize temperature-dependent molecular association with said sample based on the temperature gradient profile generated by said plurality of temperature affecting devices.

15. The method of claim 12 wherein said temperature gradient profile enhances mixing of said fluid in concert with a gravitational field.

16. The method of claim 12 wherein the temperatures produced by said plurality of temperature affecting devices are adjusted by at least one controller to produce a desired temperature gradient profile.

17. The method of claim 16 wherein said at least one controller comprises at least one sensing device and a microprocessor.

18. The method of claim 12, further comprising adjusting the temperature of said first substrate with said plurality of temperature affecting devices coupled to said first substrate to create a temperature gradient profile along a surface of said first substrate; and monitoring the hybridization of said nucleic acid samples to the array of spots in real time to determine points for a melting curve;
whereby each spot is disposed at a position representative of an approximate temperature for simultaneously determining different temperature points on a melting curve.

19. A method for molecular association comprising: generating multiple copies of a molecular probe on a substrate;
labeling said copies with an energy converting marker;
providing molecules that at least partially bind to said molecular probe, said molecules labeled with a second energy converting marker;
contacting said molecular probe copies to a sample which may contain a target, said target binding to the molecular probe in competition with the labeled at least partially binding molecules;
providing energy that may be converted by at least one of the energy converting markers; and
detecting the energy converting response of at least one of the markers to determine the binding of the target to the molecular probe.

20. The method of claim 19, wherein at least one of said first and second energy converting markers comprises a fluorescent molecule.

21. The method of claim 20, wherein said first and second energy converting markers affect each other through fluorescence resonance energy transfer when in proximity.
